(19) United States
(12) Patent Application Publication
(10) Pub. No.: US 2010/0326588 A1
(43) Pub. Date: Dec. 30, 2010

(54) Method of Manufacturing a Tire Comprising an Electrically Conductive Insert by Winding of Strips

(75) Inventors: Bernard Cappa, Clermont-Ferrand (FR); Nicolas Chevaux, Ludesse (FR)

Correspondence Address: COHEN, PONTANI, LIEBERMAN & PAVANE LLP, 551 FIFTH AVENUE, SUITE 1210, NEW YORK, NY, 10176, US

(73) Assignees: SOCIETE DE TECHNOLOGIE MICHELIN, Clermont-Ferrand (FR); MICHELIN Recherche et Technique S.A., Granges-Paccot (CH)

(21) Appl. No.: 12/740,914

(22) PCT Filed: Oct. 17, 2008
(86) PCT No.: PCT/EP2008/064049

§ 371 Date: Sep. 13, 2010

(30) Foreign Application Priority Data
Oct. 30, 2007 (FR) 0758695

(51) Int. Cl. B29D 30/08

(52) U.S. Cl. 156/117

(57) ABSTRACT

Method of manufacturing a tire (1) by winding contiguous strips onto a rotary form at a pitch and in a number of turns that is suited to the desired profile. The method comprises steps that include laying a strip to form the sublayer (13) onto the plies (15) that form the crown reinforcement belt, the strip being made of a rubbery material that is a poor conductor of electricity, laying one or more strips to form the first part of the tread (11A), these being positioned axially on one side of the tire, the strip or strips being made of rubbery materials that are poor conductors of electricity, and laying a strip to form the insert (10) and that is laid in such a way that at least one radially interior turn (100) is in contact with the sublayer (10), the strip being made of a rubbery material that is a conductor of electricity. A localized pitch offset (130) is created when winding the strip that forms the sublayer (13), the pitch offset being positioned axially in line with the radially interior part of the insert (10), so as to make the turns non-contiguous.

The invention relates to the field of tire manufacture. More specifically, the present invention deals with the known problem of the flow of electrostatic charge through a tire that has several compounds containing, by way of predominant filler, a non-conducting filler such as silica or compounds with a small carbon black filler content, at least two of these compounds making up the tread.

This problem, together with the solutions provided to it, is disclosed by way of example in publication EP 658 452 which describes a tire the tread of which is formed of a silica-based compound. According to that publication, a band of conducting rubber extends all around the circumference of the tire and connects the exterior surface of the tread to the crown plies, the electrical conductivity of which is obtained by the presence of carbon black in the elastomer matrix.

Publication U.S. Pat. No. 1,103,391 describes the case of a tire comprising several layers of rubber compounds that are not conductors of electricity and that are situated above the carcass reinforcement, as is so often the case in tires liable to run with a high stabilized operating temperature, such as the tires fitted to heavy goods vehicles or high-speed vehicles. According to that publication, each of the non-conducting layers of the tread has passing through it a circumferential insert which is introduced during the co-extrusion operation using a nozzle positioned in the stream in which the materials that make up the tread flow. This insert is made of an electrically conductive material which means that electrostatic charge flows from the surface of the tread, which is in contact with the ground, as far as the reinforcing belt which is coated with a compound that is likewise a conductor of electricity.

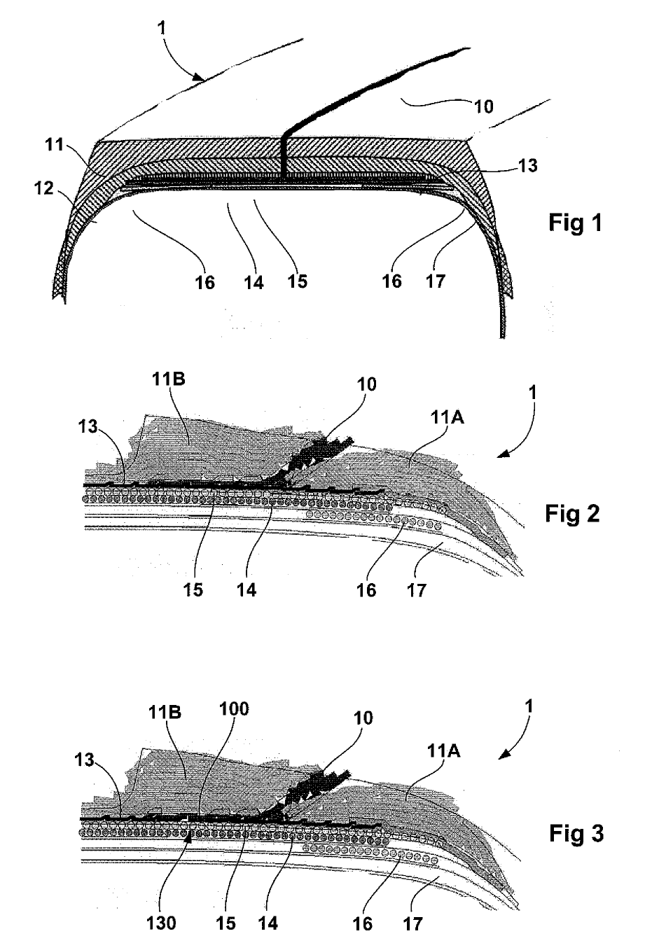

FIG. 1 depicts a schematic cross section of a tire as described in publication U.S. Pat. No. 1,103,391 and that comprises an external tread, an internal tread, which will together come under the generic heading of tread, and a sublayer. These profiled products are laid radially on top of the crown reinforcing belt (14, 15, 16). As a general rule, the sublayer, the purpose of which is to encourage adhesion between the compounds that make up the tread and the ply that forms the crown reinforcing belt, is a flat product of small thickness and small volume by comparison with the thickness and volume of the mass of rubber that forms the tread. The tread (the interior tread 12 and the exterior tread 11) is made of a rubber compound that is a poor conductor of electricity. A circumferential insert 10 passes through the tread to provide electrical connection between the exterior surface of the tread and the crown reinforcing ply.

What is meant by a material that is a poor conductor of electricity is a material that has resistivity of 10⁸ ohms/cm or more. These materials have the elastic properties suited to the function assigned to them within the tire and as a general rule are made of a rubber compound reinforced with silica-based fillers.

Likewise, what is meant by a material that is a conductor of electricity, is a material that has a resistivity of less than 10⁶ ohms/cm. As a general rule, these materials are formed from a rubber compound reinforced with carbon fillers.

When the sublayer 13 is made of a rubber material that is a conductor of electricity, there is no need for the insert 10 to be extended radially to reach the reinforcing plies of the crown belt. When it is not, when the sublayer 13 is itself made of a rubbery material that is not a conductor of electricity, it is then necessary to get the insert to pass radially through the sublayer.

The present invention is concerned more particularly with tires which are produced by winding a strip of rubber around a cylindrical or tonic rotary form.

This method of manufacture allows complex architectures to be achieved by successive winding of contiguous or non-contiguous turns, at a given pitch in the transverse direction, parallel to the axis of rotation of the tire, and with a given number of turns, so as to obtain the desired transverse profile. A cross section through a crown architecture achieved using this principle of manufacture is illustrated in FIG. 2.

It will be seen that the formation of the tread can be broken down into a number of distinct operations these consisting, in turn, in:
laying a continuous strip that forms the sublayer 13 by winding it over a number of turns onto the ply 15 that forms the crown reinforcing belt; as a general rule, just one thickness of strip will suffice, this allowing the turns to be laid contiguously or with a very small overlap;
laying one or more strips that are intended to form the first part of the tread (11A) by winding them over a number of turns, these being placed axially on one side of the green tire; the said strip or strips being made of rubbery materials that are poor conductors of electricity, so as to constitute a first lateral part 11A of the tread;
laying a strip that is intended to form the insert (10) by winding over several turns, this strip being laid in such a way that at least one radially interior turn (100) is in contact with the sublayer (10), the said strip being made of a rubbery material that is a conductor of electricity,
laying one or more strips that form the second part 11B of the tread by winding it or them over several turns; this second part is situated axially on the other side of the insert.

When the sublayer is itself made of a material that is not a conductor of electricity, which increasingly proves to be the case given the technological choices made with a view to reducing the forces that impede the forward motion of the tire, it is necessary to lay the sublayer in two parts 13A and 13B (not shown) so that a strip of insert compound can be interposed between them in order to achieve electrical continuity through the sublayer.

Each of these distinct operations can itself be broken down into elementary sequences in which it is necessary: to select and bring up the strip laying tool, to rotate the receiving surface, to lay the strip by achieving the desired number of turns, then to interrupt laying by halting the rotation of the receiving surface, and finally to retract the laying tool.

The increase in the number of layings of different products accordingly increases the number of elementary sequences and has an adverse effect on the output of the tire building machine overall.

It is an object of the invention to provide an advantageous solution to the problem of laying the insert by winding when the sublayer is made of a material that is not a conductor of electricity.

According to the invention, the sublayer can be laid without interrupting the cycle of the strip laying tool by ensuring that the turns situated axially in line with the radially interior part of the turns that form the insert are not contiguous. This method is characterized in that a pitch offset in the strip that forms the sublayer is locally created. This pitch offset is positioned axially in line with the radially interior part of the insert, so as to make the turns non-contiguous at this precise point.

During the vulcanization operation, the insert compound enters the space left empty between the two non-contiguous turns of the sublayer, and comes into contact with the crown reinforcing ply. An electrically conductive path is therefore created between the radially external part of the insert which is in contact with the ground and the crown reinforcing ply so that electrostatic charge can flow freely through the tire mounted on its rim, the said rim itself being mounted on the vehicle.

The method according to the invention thus makes it possible to reduce the number of elementary sequences required to create a tread and a sublayer which are made of materials that are poor conductors of electricity and through which there passes an insert made of a rubbery material that is a conductor of electricity. Specifically, the sublayer can be created by winding the strip continuously in a single step, without there being any need to interrupt the process in order to lay an insert.

The description which follows illustrates one particular embodiment of the invention and relies on FIGS. 1 to 5 in which:

FIG. 1 depicts a cross section through a tire comprising a sublayer and an insert,

FIG. 2 is a cross section through a green tire produced by winding strips and comprising a sublayer that is a conductor of electrical charge,

FIG. 3 is a cross section through a tire produced according to a method according to the invention,

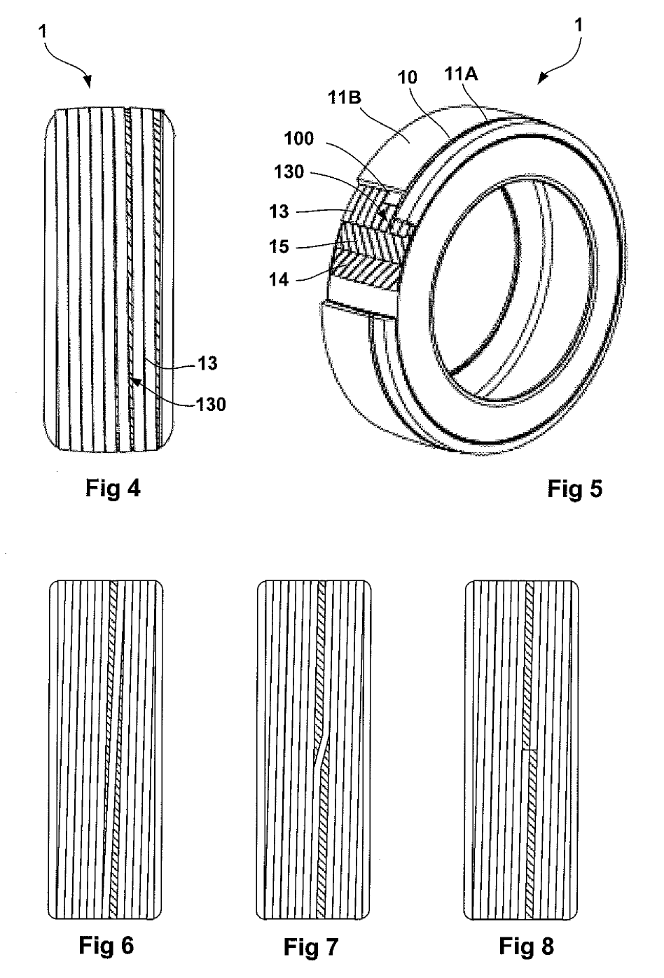

FIGS. 4 and 5 are schematic perspective views of the cutaway of a green tire produced according to a method according to the invention,

FIGS. 6, 7 and 8 illustrate possible embodiments of a pitch offset according to the invention.

FIG. 1 is a cross section through a tire 1 comprising a carcass reinforcing ply 17, surmounted by a collection of plies that make up the crown reinforcing ply 14, 15, 16, on which a sublayer 13, an interior tread 12 and an exterior tread 11 have been laid.

This tire has been produced using a known method, like the one described in the abovementioned U.S. Pat. No. 1,103,391. According to this method, the various rubber profiles are created on extrusion tools that deliver a band of composite rubber material with the desired final profile. The continuous band is, according to a method that is likewise known, cut into pieces of given length, which pieces are wound around a rotary form on which the crown reinforcing plies have already been laid.

FIG. 2 is a cross section through a green tire produced according to the known method of strip winding. The strips are wound in turns, generally contiguous turns, around a rotary form (not depicted) with a given pitch and a given number of turns to reconstruct the desired form of transverse profile. To do this, the transverse rate of travel of the means delivering the strip and the rotational speed of the rotary form are combined to suit.

The rotary form may just as easily be of cylindrical or of toroidal shape. The carcass reinforcing ply 17 is capped by the reinforcing plies 14, 15, 16 which constitute the crown belt plies. These plies, together with the carcass reinforcing ply 17, are formed as metal reinforcements coated with rubber compounds that are conductors of electricity. The carcass reinforcing ply 17 connects the crown region to the lower region of the tire.

The sublayer 13 covers the last crown reinforcing ply 15 situated radially on the outside. This sublayer, of small thickness, is formed by the juxtaposition of turns which are contiguous edge to edge or have a very small overlap. In the case of FIG. 2, the sublayer has been made of a material that is a conductor of electricity.

Hence, all that is necessary is for the turns of the insert 10 to be in contact with the sublayer in order to establish an electrical path between the external part of the insert, which is in contact with the ground, and the internal part of the sublayer. Said electrical charge flows via the sublayer through the crown belt, the carcass reinforcing ply and the lower region as far as the rim.

FIG. 3 shows a cross section through a green tire 1 produced according to a method according to the invention and in which the sublayer is made of a rubbery material that is a poor conductor of electricity. The sublayer is wound directly onto the surface of the crown reinforcing ply 15.

A pitch offset 130 has been created during the winding of the turns that make up the sublayer 13. This pitch offset is positioned axially in line with the insert 10, so that at least one of the turns of the insert 100 is in contact with the crown reinforcing ply 15 via this gap 130 made between the two turns of the sublayer. Thus, the laying of the strip that forms the sublayer is not interrupted with a view to fitting a strip that is intended to form the base of the insert in contact with the crown reinforcing ply 15.

It is also possible to create a sharp offset, which gives rise to a localized discontinuity of the winding as illustrated in FIG. 7.

The magnitude of the pitch offset can advantageously be at least greater than half the width of the strip and less than the width of the said strip. By way of example, a pitch offset of 40 mm for a strip 20 mm wide has delivered good results.

Running tests have shown that the localized absence of the sublayer between the carcass reinforcing ply and the insert was not detrimental to the performance of the tire provided that the compound of which the insert was formed was compatible with the compound of which the reinforcing ply was formed.

FIG. 4 schematically illustrates the green tire after the laying of the sublayer. The pitch offset 130 can be seen between the two turns placed radially in line with the insert.

FIG. 5, which depicts a cutaway, is also giving a view of the stack of layers of strips that make up the various extrusion profiles of the green tire.

The pitch offset may be realized in various ways by varying at a greater or lesser rate the transverse speed of travel of the means that delivers the strip.

According to a first embodiment, arrangements are made for the transverse speed of travel to be doubled or even tripled during one rotation of the rotary form. This then yields an even offset like the one illustrated in FIG. 6.

It is also possible to produce a very rapid transverse shift like the one illustrated in FIG. 7.

When the means delivering the strip onto the rotary form is formed of an assembly comprising an extrusion nozzle applying the compound directly onto the laying surface, as described by way of indication in unpublished application No. FR 07/03434, the flow of material leaving the nozzle can easily be interrupted for a complete revolution, leaving the transverse speed of travel of the means that delivers the strip to the rotary form unchanged, in order to obtain a pitch offset like the one illustrated in FIG. 8.

1. A method of manufacturing a tire by winding contiguous strips onto a rotary form at a pitch and in a number of turns that is suited to the desired profile, comprising the steps of:
laying a strip to form a sublayer onto plies that form the crown reinforcement belt, the strip being made of a rubbery material that is a poor conductor of electricity;
laying one or more strips to form a first part of a tread, these being positioned axially on one side of the tire, the strip or strips that form the tread being made of rubbery materials that are poor conductors of electricity;
laying a strip to form an insert and that is laid in such a way that at least one radially interior turn is in contact with the sublayer, the strip that forms the insert being made of a rubbery material that is a conductor of electricity; and
locally creating a pitch offset when the strip that forms the sublayer is being wound, the pitch offset being positioned axially in line with a radially interior part of the insert, so as to make the turns non-contiguous.

2. The method of manufacture according to claim 1, further comprising laying one or more strips to form a second part of the tread and that are positioned axially on another side of the insert, the strip or strips that form the second part of the tread being made of rubbery materials that are poor conductors of electricity.

3. The method of manufacture according to claim 1, wherein a distance between edges of two consecutive turns that form the sublayer at the pitch offset is locally greater than half the width of the strip.

4. The method of manufacture according to claim 1, wherein a distance between edges of two consecutive turns that form the sublayer at the pitch offset is locally less than or equal to the width of the strip.
